(19) United States
(12) Patent Application Publication
(10) Pub. No.: US 2010/0102034 A1
(43) Pub. Date: Apr. 29, 2010

(54) Apparatus for Monitoring Vacuum

(75) Inventor: Roman Renz, Berlin (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, München (DE)

(21) Appl. No.: 12/532,208

(22) PCT Filed: Mar. 18, 2008
(86) PCT No.: PCT/EP08/53211

§ 371 Date: Sep. 21, 2009

(30) Foreign Application Priority Data
Mar. 23, 2007 (DE) 10 2007 014 940.0

(51) Int. Cl. H01H 33/66

(52) U.S. Cl. 218/140; 200/11 R

(57) ABSTRACT

A leak sensor for monitoring a vacuum in a vacuum interrupter has a deformable separating wall, particularly in the form of a membrane or a bellows. The separating wall is connected to a vacuum chamber of a vacuum interrupter through a measuring opening. When the vacuum chamber of the vacuum interrupter is aerated or vented, the membrane or bellows is deformed. That deformation is detectable by a mechanical indicator device, an optical device or an electro-optical device.

The invention relates to an apparatus for monitoring the vacuum in a vacuum chamber, in particular in a vacuum interrupter, with a component, which changes its physical properties depending on the pressure in the vacuum chamber, and a device for detecting the changes in the properties of the component.

Such an apparatus is known from DE 34 24 339 and comprises a pair of electrodes which is arranged in the interior of the vacuum interrupter and forms an auxiliary spark gap. The auxiliary spark gap is dimensioned in such a way that, in the case of a faultless vacuum in the vacuum interrupter, a current flow occurs which is insufficient for exciting a light-emitting diode. If, however, the pressure in the vacuum interrupter increases, as a result of a leak, to a higher pressure which is no longer sufficient for proper switching, a current flows via the auxiliary spark gap, which current is sufficient for causing a diode to illuminate if a voltage pulse is generated when the vacuum interrupter is switched on with the aid of a piezoelectric element.

One disadvantage with the known apparatus for monitoring the vacuum is the complicated mechanics of the apparatus for generating a voltage pulse and another disadvantage is the fact that it is not possible for a measurement to be carried out during routine operation of the vacuum interrupter.

DE 195 39 535 A1 has described a method for monitoring the pressure of a vacuum interrupter which is designed to carry out a measurement which is independent of the gas type, interpretation-free, noninvasive and contactless during operation of the vacuum interrupter. For this purpose it is provided for ultrasound waves to be fed into the vacuum interrupter and for the gas density in the vacuum interrupter to be determined from the ratio between the reflected and transmitted amplitude. In a modified method, a determination of the stress state of metal flanges or shields is carried out with the aid of ultrasound, with acoustic natural resonances being used. The change in the internal pressure in a vacuum interrupter in particular results in a change in resonance frequency of the component parts used. Monitoring of the pressure can be provided on the basis of a reduction in the resonance frequency and a change in the attenuation of the amplitude of the natural oscillations.

Against the background of this prior art, the invention is based on the object of providing an apparatus for monitoring the vacuum of a vacuum chamber which can be used in a simple and reliable manner as a leak sensor, which allows continuous monitoring in particular during operation of a vacuum interrupter.

This object is achieved according to the invention by virtue of the fact that the component is a deformable separating wall between the vacuum chamber and the surrounding environment of the vacuum chamber, and the fact that an extreme value of the deformation of the separating wall can be detected by the device for detecting the changes in the properties of the component.

The invention is based on the knowledge that a voltage drop in a vacuum chamber, in particular in a vacuum interrupter, generally takes place suddenly and is sufficient for distinguishing between two extreme states.

In a particularly simple exemplary embodiment, the deformable separating wall comprises an elastically deformable membrane, in particular a metallic membrane. This membrane can in particular be formed in the manner of a frog clicker and consist of spring steel which is bent in such a way that it has a stable and a metastable state. When the vacuum interrupter is aerated, the membrane is bent in a stable state until it jumps suddenly, by virtue of buckling, into a metastable state. A design of the membrane with two stable states is alternatively likewise possible.

In accordance with a further preferred exemplary embodiment, the deformable separating wall is formed by a bellows, in particular a metal bellows. In order to avoid overstressing of the bellows and to attain limiting of the excursion of the bellows, it is expedient if at least one stop is provided, which limits the deformation of the bellows.

The deformation of the membrane acting as the separating wall or of the bellows forming a separating wall can be transferred to an indicating element, which can be moved between end positions, which are assigned to the unaerated and the aerated state of the vacuum chamber, in particular of a vacuum interrupter.

One particularly simple possibility consists in the indicating element being a gauging rod, which is arranged in an indicator housing and protrudes with its free end out of the indicator housing in the event of aeration of the vacuum.

In a preferred exemplary embodiment, the position of the indicating element is detected optically or optoelectronically.

For this purpose, in particular a light beam bundle emerging from an optical waveguide can be modulated depending on the position of the indicating element.

A particularly simple arrangement results if the light emerging from the optical waveguide can be interrupted on its path to an optical waveguide receiving the light by a diaphragm or by being pushed away by a mirror.

For manual monitoring, an arrangement in which the indicating element is equipped with two differently colored filters which transmit a differently colored light to the optical waveguide receiving the light at each of the two end positions of the indicating element is particularly suitable. In this case, it is particularly expedient if the transmitted light beam has a broad color spectrum and in particular represents a white light.

The invention will be described in more detail below using exemplary embodiments with reference to the drawings, in which:

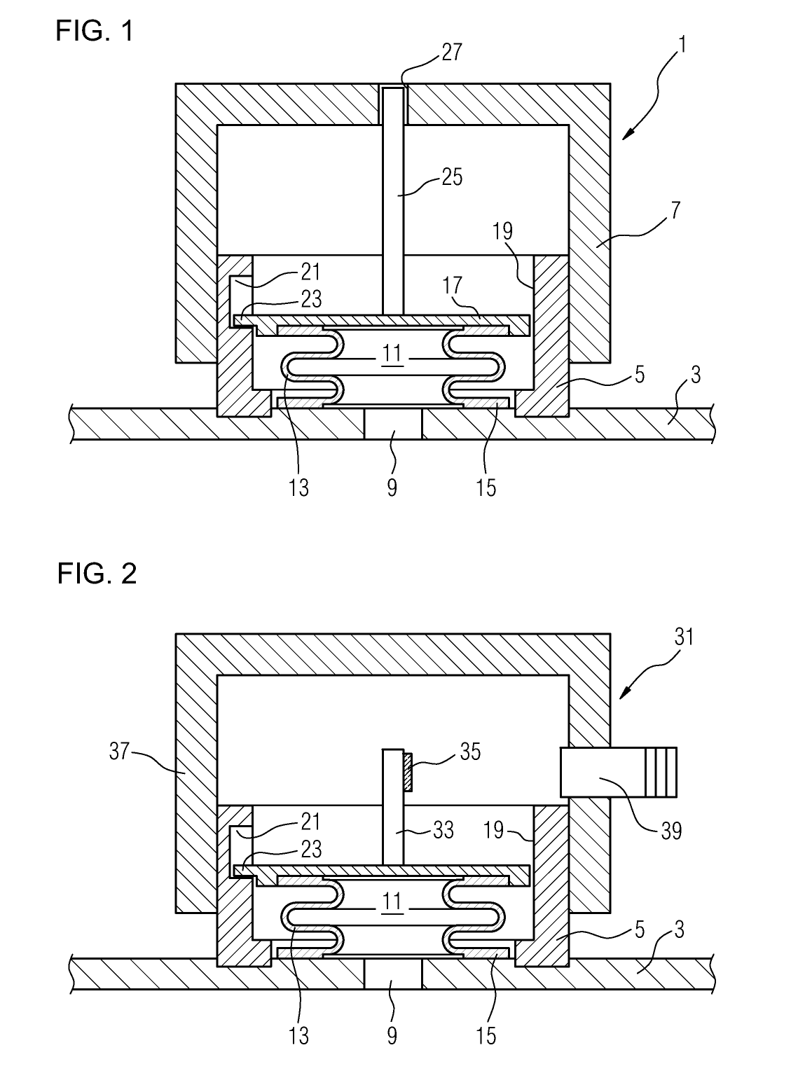

FIG. 1 shows a mechanical apparatus for monitoring the vacuum in a vacuum chamber with an indicator rod for indicating an aerated state,

FIG. 2 shows an apparatus for monitoring the vacuum, in which a light beam serves the purpose of detecting the position of a mirror,

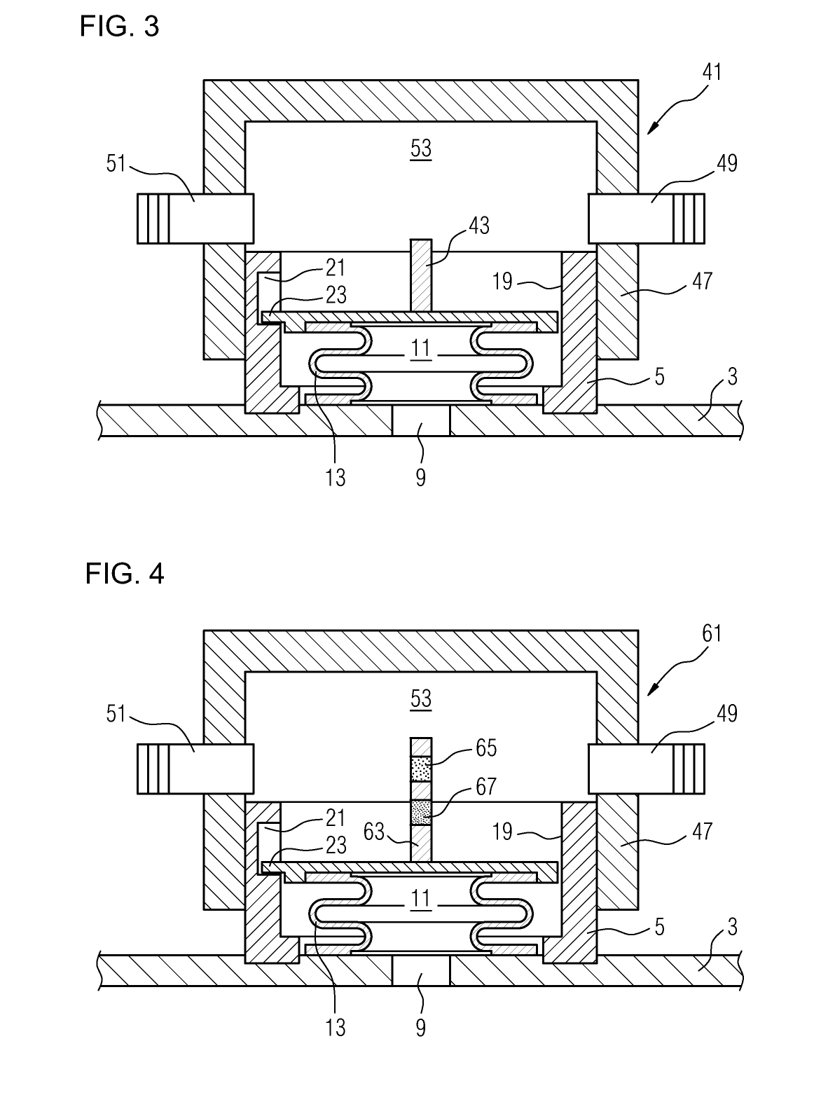

FIG. 3 shows a further exemplary embodiment of an arrangement in accordance with the invention, in which a light beam bundle can be interrupted with the aid of a shadow diaphragm, and

FIG. 4 shows an apparatus for monitoring the vacuum in a vacuum chamber with an optical arrangement which makes it possible to assign different colors to the aerated and the unaerated state of a vacuum chamber.

FIG. 1 shows a schematic illustration, in section, of an apparatus for monitoring the vacuum in a vacuum chamber, which is referred to as leak sensor 1 below for short. The leak sensor 1 is fastened on the housing 3 of a vacuum interrupter (not illustrated in any greater detail in FIG. 1), in which a high vacuum needs to be maintained in order to ensure the functional reliability of said vacuum interrupter. Different causes, such as corrosion, external electrical flashovers in a ceramic of the vacuum interrupter or material faults, for example, can result in the vacuum interrupters being aerated. In such cases, the pressure in the interior of the vacuum interrupter often increases suddenly, with the result that a precise internal pressure measurement is not required for monitoring the functionality.

The leak sensor 1 illustrated in FIG. 1 is therefore designed in such a way that it makes it possible to indicate whether a vacuum is present or not, depending on the state of aeration of the vacuum of a vacuum interrupter.

In the exemplary embodiment illustrated in FIG. 1, a cylinder nozzle 5 is fastened on the housing 3, and a pot-shaped indicator cap 7 is fastened on said cylinder nozzle by means of adhesive bonding, welding or screwing.

A measuring opening 9, which opens out into the interior 11 of a metal bellows 13, is provided in the housing 3 of the vacuum interrupter. The bellows 13 illustrated schematically in FIG. 1 preferably has a plurality of bellows corrugations, with the result that a sufficient excursion and a sufficient force are available if the bellows 13 is expanded from the initial position shown in FIG. 1. The bellows 13 is joined, in particular welded, in a vacuum-tight manner to the housing 3 at the lower bellows end 15 of said bellows.

The upper bellows end in FIG. 1 bears a disk cam 17 and a means (not illustrated in the drawing) for sealing off the vacuum and the bellows 13.

The cylinder nozzle 5 of the leak sensor 1 has a cylindrical inner wall 19, in which at least one axially extending cutout 21 is provided, and engages the at least one stop finger 23 fitted on the disk cam 17. The cutout 21 forms a lower and an upper stop for the stop finger 23 in FIG. 1. The stops are each assigned to the extreme values of the deformation of the bellows 13 and therefore limit the excursion of the bellows 13 and of the disk cam 17.

An indicator rod 25, which protrudes with its free end into an indicator opening 27 formed in the indicator cap 7, is fastened on the disk cam 17.

Given the maximum compression (illustrated in FIG. 1) of the bellows 13 which is assigned to the unaerated vacuum interrupter, the free end of the indicator rod 25 is withdrawn and therefore hidden. If, however, the vacuum chamber of the vacuum interrupter is aerated, the bellows 13 of the leak sensor 1 is expanded until the stop finger 23 stops at the other end in the cutout 21. In this case, the disk cam 17 and the indicator rod 25 fastened thereon are moved so far out of the indicator opening 27 that the free end of the indicator rod 25 is easily visible from the outside. This is in particular the case when the free end of the indicator rod 25 is correspondingly identified by color in order to provide a good contrast with the color of the outer side of the indicator cap 7.

It is also possible for the free end of the indicator rod 25 when it emerges from the indicator cap 7 to be used not only as a visual indicator but also as an actuating plunger for generating a warning signal.

Vacuum interrupters are often encapsulated and are then no longer easily visible from the outside.

In the exemplary embodiment of a leak sensor 31 illustrated in FIG. 2, an optical indicator is provided, with the result that even encapsulated vacuum interrupters can be continuously monitored with respect to their state of aeration in a simple and reliable manner.

The design of the leak sensor 31 corresponds to the exemplary embodiment described in connection with FIG. 1 with respect to a series of component parts. In FIG. 2, therefore, the same reference symbols have been used for corresponding parts.

In the case of the leak sensor 31 illustrated in FIG. 2, a mirror holder 33, which bears a mirror 35, is fastened on the disk cam 17. The mirror 35 may be a plane mirror or else a convex mirror. An indicator cap 37 which is screwed on, for example, at the cylinder nozzle 5 is provided with an optical waveguide connection 39 for an optical waveguide. The optical waveguide connection 39 illustrated schematically in FIG. 2 has an optical element which is designed to apply a light beam bundle to the mirror 35, which light beam bundle passes back to the optical waveguide again via the optical waveguide connection 39 once it has been reflected at the mirror 35. Said optical waveguide is connected to a digital indicator unit via an optical coupling-out device (not illustrated in the drawing).

A leak sensor 1 illustrated in FIG. 2 makes it possible in a simple manner to monitor the vacuum in a vacuum chamber, in particular the vacuum chamber of a vacuum interrupter. If aeration occurs which impairs the operation of the vacuum interrupter, the bellows 13 is deformed and in the process moves the mirror 35 out of the beam path of the light fed in via the optical waveguide connection 39. As soon as this is the case, the mirror 35 can no longer reflect the light beam bundle used as measurement light back into the optical waveguide connection 39, with the result that an alarm signal or leak signal can be triggered in the connected digital display on the basis of the light which no longer returns.

FIG. 3 shows a further example of optical signal generation for a leak sensor 41. The component parts which have already been described in connection with FIGS. 1 and 2 have been provided with the reference symbols already known. As a deviation from the exemplary embodiment illustrated in FIG. 2, the mirror holder 33 is replaced by a shadowing diaphragm 43. The leak sensor 41 has an indicator cap 47 with two mutually opposite optical waveguide connections 49 and 51. The arrangement of the optical waveguide connections 49 and 51 is in this case configured in such a way that, in the case of the presence of a vacuum after the connection of a first and a second optical waveguide, the light of the first optical waveguide can pass through the interior 53 of the indicator cap 47 to the second optical waveguide.

As long as the vacuum interrupter is not aerated, there is therefore light transmission through the indicator cap 47. However, the light transmission is interrupted when, as a result of aeration, the bellows 13 expands and in the process the shadowing diaphragm 43 enters the beam path between the optical waveguide connection 49 and the optical waveguide connection 51. If this is the case, the optical signal transmission is interrupted, which can be utilized for optoelectronically providing a corresponding display in a digital display or else for generating a leak signal or a leak alarm signal.

Instead of an optoelectronic evaluation of the light emerging from the indicator cap 47, it is also possible to bring this light, via an optical waveguide, to a point at which a visual check can be carried out directly by monitoring personnel. For this purpose, a planar end face of an optical waveguide can be used as the indicator lamp, for example.

A visual check of the state of aeration with two colors, for example the color green for the unaerated state of a vacuum interrupter and the color red for the aerated state of a vacuum interrupter, is possible with an arrangement in accordance with the exemplary embodiment illustrated in FIG. 4.

The exemplary embodiment of the leak sensor 61 illustrated in FIG. 4 differs from the exemplary embodiment illustrated in FIG. 3 in that, instead of a shadowing diaphragm, a diaphragm arrangement 63 with color filters 65, 67 is used. In the arrangement for a leak sensor 61 illustrated in FIG. 4, the white light fed in from the optical waveguide connection 49 passes via the diaphragm arrangement 63 and the color filter 65 to the optical waveguide connection 51. From there, it is further-processed optoelectronically or purely visually. In the case of a visual check, it is expedient if the color filter 65 is green, such that the end side of the optical waveguide available to the viewer then appears green.

In the event of a leak, the bellows 13 expands as far as it is allowed to do so by the cutout 21 and the stop finger 23. In this case, the arrangement in the exemplary embodiment shown in FIG. 4 is configured in such a way that the color filter 67 assumes the position which was originally assumed by the color filter 65. In this way it is then possible to represent a display with a different color, for example a red color, at the end of the output optical waveguide.

1-10. (canceled)

11. An apparatus for monitoring a vacuum in a vacuum chamber, the apparatus comprising:
a component changing its physical properties depending on pressure in the vacuum chamber, said component being a deformable separating wall between the vacuum chamber and the environment surrounding the vacuum chamber; and
a device for detecting the changes in the properties of said component, said device configured for detecting an extreme value of a deformation of said separating wall.

12. The apparatus according to claim 11, wherein said separating wall is an elastically deformable membrane.

13. The apparatus according to claim 11, wherein said separating wall is formed by a bellows.

14. The apparatus according to claim 13, wherein said bellows is a metal bellows.

15. The apparatus according to claim 13, which further comprises at least one stop limiting deformation of said bellows.

16. The apparatus according to claim 11, wherein said device is an indicating element configured to be moved between two end positions, said deformation of said separating wall to be transferred to said indicating element.

17. The apparatus according to claim 16, which further comprises an indicator housing, said indicating element being a gauging rod entirely hidden by said indicator housing upon a minimum deformation of said separating wall and having an indicating end protruding out of said indicator housing and being visible upon a maximum deformation of said separating wall.

18. The apparatus according to claim 16, which further comprises an optical waveguide emitting a light beam bundle being modulated depending on a position of said indicating element.

19. The apparatus according to claim 18, which further comprises another optical waveguide for receiving the light beam, and at least one diaphragm for interrupting the light beam on a path from said optical waveguide emitting the light beam to said other optical waveguide for receiving the light beam.

20. The apparatus according to claim 19, wherein said at least one diaphragm is two diaphragms of said indicating element having differently colored filters for passing differently colored light to said other optical waveguide for receiving the light beam at each of said two end positions of said indicating element.

21. The apparatus according to claim 11, wherein the vacuum chamber is in a vacuum interrupter.
